(19) United States
(12) Patent Application Publication
(10) Pub. No.: US 2006/0286237 A1
(43) Pub. Date: Dec. 21, 2006

(54) Use of divanillin as a flavouring agent

(76) Inventors: Ingo Reiss, Holzminden (DE); Ian-Lucas Gatfield, Hoexter (DE); Gerhard Krammer, Wagnerstr (DE); Albert Clerc, Holzminden (DE); Guenter Kindel, Hoexter (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 10/547,981

(22) PCT Filed: Feb. 28, 2004
(86) PCT No.: PCT/EP04/02004

§ 371 Date: Sep. 8, 2005

(30) Foreign Application Priority Data
Mar. 8, 2003 (DE) 103 10 204.3

(51) Int. Cl. A23L 2/56

(52) U.S. Cl. 426/534

(57) ABSTRACT

The use of 6,6′-dihydroxy-5,5′-dimethoxy-[1,1′-biphenyl]-3,3′-dicarboxaldehyde (divanillin) as a flavouring is described. Also described are flavouring compositions and foodstuffs comprising divanillin in a sensorially effective amount.

### BACKGROUND OF THE INVENTION

1. Field of the invention

The invention relates to the use of 6,6′-dihydroxy-5,5′-dimethoxy-[1,1′-biphenyl]-3,3′-dicarboxaldehyde (CAS No. 2092-49-1) (synonyms: 2,2′-dihydroxy-3,3′-dimethoxy-5,5′-diformylbiphenyl or 5,5′-bivanillin or dehydrodivanillin)—divanillin for short hereinbelow—as a flavouring. The invention relates further to the use of divanillin for imparting or enhancing particular taste impressions.

Divanillin has the following structure:

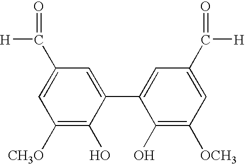

2. Related Art of the Invention

Various flavouring and taste-imparting substances are already known which impart a rich taste impression of creaminess on sensory investigation. These may be volatile or non-volatile compounds. Examples of volatile flavourings which may be mentioned include delta-lactones, acetoin and acetoin esters, esters of higher fatty acids, or long-chain saturated or unsaturated aldehydes, such as 12-methyltridecanal, 2,4-decadienal or dodecadienal. Examples of non-volatile compounds which may be mentioned include lipolysed fats, modified starches, xylo-oligosaccharides, modified sugars, sugar esters, amino acids or peptides.

### SUMMARY OF THE INVENTION

The object of the present invention was to provide novel flavourings which are to impart in particular a rich taste impression of creaminess, adherence, milk fattiness and/or sweetness. Our own investigations have shown, surprisingly, that divanillin imparts a pleasant, adherent and rich taste impression of creaminess, milk fattiness, butteriness and sweetness and therefore achieves the object set. This is particularly surprising because divanillin is described, for example in JP 07-179853 A2, as an odourless and tasteless substance.

Accordingly, divanillin is also not used as a flavouring according to JP 07-179853 A2 but for a completely different purpose, namely as an antioxidant; in particular to increase stability in cosmetics, pharmaceuticals or foodstuffs, the use of divanillin as an antioxidant is described, the amount of divanillin in the finished preparations being given as from 0.001 to 5 wt. %, in particular from 0.01 to 1 wt. %.

Divanillin is additionally mentioned in the literature as a component that plays a part in the structure of lignin. Thus, for example, divanillin can be detected in the chemical or enzymatic degradation of wood (Geochimica et Cosmochimica Acta, 1992, 56, 4025-4043; Chem. Ber., 1965, 98, 1879-1892).

Divanillin is additionally used as a skin-lightening agent (JP 06-145040 A2) and as a fixative in perfume oils (e.g. JP 04-255798 A2).

Processes for the preparation of divanillin with the aid of oxidising agents are found, for example, in Biosci. Biotechnol. Biochem., 1999, 63 (2), 390-394; J. Org. Chem., 1957, 22, 1299-1232 or also Chem. Ber., 1961, 94, 3227-3228.

Enzymatic synthesis starting from vanillin with the aid of peroxidases and hydrogen peroxide is described in Chimia, 1972, 26 (7), 366-368. A similar reference is to be found in Food Chemistry, 1997, 60 (1), 43-51.

Vanillin is the determining component in vanilla pods. During the production process from the harvested green vanilla pod to the fermented brown or black pod more than half the vanillin originally present is lost as a result of enzymatic degradation reactions; the vanillin content is reduced during the fermentation from approximately from 5 to 6 wt. % originally to from 2 to 3 wt. % (20,000 to 30,000 ppm).

Divanillin was hitherto not known as an ingredient of vanilla pods—regardless of the nature of the formation or treatment. The occurrence of divanillin in amounts in the range from 10 to 100 ppm, according to the country of origin, in the vanilla pod and in the extracts resulting therefrom (see Example 3) has been demonstrated for the first time within the context of the works underlying this invention.

The use of divanillin as a flavouring and taste-imparting substance, i.e. as a flavouring component, is not described in the literature.

Owing to its pleasant, adherent and rich taste impression of creaminess, milk fattiness, butteriness and sweetness, divanillin is suitable very especially for incorporation into low-fat and reduced-fat semi-finished food products and ready-to-eat foodstuffs (although fat-rich products are also affected positively by the use of divanillin). Divanillin is used thereby as such or in the form of a flavouring composition, i.e. together with one or more further flavouring and taste-imparting substances. By the addition of divanillin, a fuller taste, creaminess and milk fattiness can be imparted to low-fat and fat-reduced products, which are becoming increasingly more important and whose creamy, full nature is impaired in comparison with full-fat products. Examples of low-fat and reduced-fat products are reduced-fat margarines, reduced-fat milk, low-fat yoghurts, low-fat curd cheese, instant desserts and reduced-fat ice-cream.

Within the scope of the present text a “foodstuff” is understood as meaning substances that are intended for consumption by humans in the unchanged, prepared or processed state; in this respect, foodstuffs are also understood as meaning casings, coatings or other coverings which are intended to be consumed at the same time, or whose consumption at the same time is to be expected.

A ready-to-eat foodstuff is to be understood as being a foodstuff that already contains all the substances that determine the taste. The term “ready-to-eat foodstuff” includes drinks as well as solid or semi-solid ready-to-eat foodstuffs. There may be mentioned as examples: packet soups, to which water must added and which must then be heated before consumption, and frozen products, which must be thawed and heated to the temperature for eating before consumption. Ready-to-eat foodstuffs also include the products margarine, milk, yoghurt, curd cheese, instant desserts and ice-cream, which have already been mentioned.

The term “semi-finished food products” refers to foodstuffs that are intended to be consumed only in the further processed state, after the addition of flavouring or taste-imparting substances that determine (or play a part in determining) the sensory impression.

“Flavouring compositions” are not foodstuffs but are concentrated preparations of flavourings and/or taste-imparting substances which are intended to impart a particular aroma or taste to a foodstuff.

A preferred flavouring composition for flavouring a foodstuff comprises
divanillin (preferably in the amount indicated below),
vanillin and
optionally one or more further flavouring and/or taste-imparting substances,
   the ratio of the amount of divanillin to vanillin being greater than 1:200, preferably greater than 1:100.

Owing to its higher relative proportion of divanillin, such a flavouring composition is markedly superior to a flavouring composition obtained by extraction of the vanilla pod.

Also preferred is a flavouring composition for flavouring a foodstuff that comprises synthetic divanillin, natural or synthetic vanillin and optionally one or more further flavouring and/or taste-imparting substances.

Such a flavouring composition differs from flavouring compositions obtained by extraction of the vanilla pod in that synthetic divanillin is used, which is of course less expensive than the natural divanillin from the vanilla pod. Preferably, the vanillin is also of synthetic origin. The person skilled in the art is capable of distinguishing between synthetic divanillin and natural divanillin.

A further preferred flavouring composition for flavouring a semi-finished product or a ready-to-eat foodstuff comprises divanillin in an amount of from 0.1 to 50 wt. %, preferably from 0.1 to 10 wt. %, more preferably from 0.2 to 5 wt. %, based on the total weight of the flavouring composition, as well as one or more further flavouring and/or taste-imparting substances. The flavouring composition (in accordance with the above definition) is not itself a ready-to-eat foodstuff.

Ready-to-eat foodstuffs or semi-finished food products according to the invention comprise divanillin in an amount in the range from the taste threshold value to 0.00099 wt. % (9.9 ppm), based on the total weight of the foodstuff, as well as, optionally, one or more further flavouring and/or taste-imparting substances. The taste threshold value of divanillin has been determined to be markedly below 1 ppm.

Particular preference is given to ready-to-eat foodstuffs or semi-finished food products according to the invention that comprise divanillin in an amount in the range from 0.0002 to 0.0009 wt. % (from 2 to 9 ppm), and very particular preference is given to amounts of divanillin in the range from 0.0004 to 0.0007 wt. % (from 4 to 7 ppm).

The described ready-to-eat foodstuffs and semi-finished food products according to the invention differ from the foodstuffs derivable from JP 07-179853 A2 by the smaller proportion of divanillin. In fact, the amount of divanillin must be markedly above the values that are preferred for the purposes of the present invention if divanillin is to act as an antioxidant. Moreover, at the higher concentration values preferred according to JP 07-179853 A2, the taste impression of richness, creaminess etc. that is imparted by the divanillin diminishes in favour of a vanilla-like individual taste, which is perceived as disadvantageous in the present context.

Preference is given also to ready-to-eat foodstuffs or semi-finished food products that comprise
divanillin (preferably in the amount indicated above),
vanillin and
optionally one or more further flavouring and/or taste-imparting substances,
   the ratio of the amount of divanillin to vanillin being greater than 1:200, preferably greater than 1:100.

And finally, preference is given also to ready-to-eat foodstuffs or semi-finished food products that comprise
synthetic divanillin (preferably in the amount indicated above),
vanillin and
optionally one or more further flavouring and/or taste-imparting substances.

Regarding the differences compared with ready-to-eat foodstuffs or semi-finished food products that comprise a vanilla pod extract, reference is made to our comments in relation to the flavouring composition according to the invention, which apply analogously in this respect.

The invention relates also to a method of flavouring a foodstuff, in which a sensorially effective amount of divanillin is added to the foodstuff to be flavoured, the amount of added divanillin not exceeding 0.00099 wt. %, based on the total weight of the flavoured foodstuff. Regarding the particularly preferred ranges of amounts for the divanillin to be added, reference is made to the comments in relation to the preferred amounts in ready-to-eat foodstuffs.

It is clear from the above that, in particularly preferred embodiments of the invention, divanillin is used in combination with other flavouring and/or taste-imparting substances and/or extracts of natural substances. In this manner, a particularly rounded and refined sensory profile can be achieved.

Examples of taste-imparting substances or flavourings which can be used together with the divanillin are to be found, for example, in K. Bauer, D. Garbe and H. Surburg, Common Fragrance and Flavor Materials, 4th Ed., Wiley-VCH, Weinheim 2001. Examples which may be mentioned include: esters (saturated or unsaturated), for example ethyl butyrate, allyl caproate, benzyl acetate, methyl salicylate; organic acids (saturated and unsaturated), for example butyric acid, acetic acid, methylbutyric acid, caproic acid; alcohols (saturated and unsaturated), for example ethanol, propylene glycol, octenol, cis-3-hexanol, benzyl alcohol, phenylethyl alcohol; aldehydes (saturated and unsaturated), for example acetaldehyde, isobutyraldehyde, nonadienal, benzaldehyde, 3-phenylacetaldehyde; ketones, for example menthone; ethers, for example 4-hydroxy-5-methylfuranone, 3-hydroxy-4,5-dimethyl-2-(5H)-furanone, 2,5-dimethyl-3-hydroxy-2(3H)-furanone, 2(5)-ethyl-4-hydroxy-5(2)-methyl-3(2H)-furanone, p-methoxybenzaldehyde, guaiacol, methoxyvinylphenol; acetals, for example acetaldehydediethylacetal; lactones, for example gamma-decalactone; terpenes, for example limonene, linalool, terpinene, terpineol, citral (geranial and neral), menthol; sulfides and disulfides, for example dimethyl sulfide, difurfuryl disulfide, methylthiopropanal; thiols, for example methylfuranthiol; pyrazines and pyrrolines, for example methylpyrazine, acetylpyrazine, 2-propionylpyrroline, 2-acetylpyrroline.

In order to achieve a rounded and fuller, creamier sensory profile, compositions of flavouring and taste-imparting substances that additionally comprise, as well as divanillin, a lactone and/or an acid are advantageous. Advantageous lactones are, for example, delta-octalactone, delta-nonalactone, massoilactone, delta-undecalactone, delta-dodecalactone, delta-decalactone, gamma-nonalactone, gamma-decalactone, gamma-dodecalactone, gamma-tetradecalactone; advantageous acids are, for example, butyric acid, isobutyric acid, isovaleric acid, caproic acid, caprylic acid, capric acid, lauric acid, myristic acid and their esters.

The flavouring compositions according to the invention and the ready-to-eat foodstuffs or semi-finished food products according to the invention can comprise the basic substances, auxiliary substances and additives conventional for foodstuffs or snacks. They may further comprise water. Typically, the amount of conventional basic substances, auxiliary substances and additives and/or the content of water is in the range above 5 wt. % (based on the total weight of the ready-to-eat foodstuff or the semi-finished food product) and is less than 80 wt. %. Of course, the amounts used may also be smaller or greater.

If the flavouring compositions according to the invention or the ready-to-eat foodstuffs or semi-finished food products according to the invention also comprise vanillin in addition to divanillin, the weight ratio of divanillin:vanillin is advantageously in the range from 1:5 to 1:50, preferably in the range from 1:10 to 1:30. The mentioned ratios are particularly advantageous for cream-vanilla flavours and impart taste impressions which cannot be achieved by an extract of vanilla pods.

Foodstuffs according to the invention are, for example, baked articles (e.g. dry biscuits, cakes, other baked articles), confectionery (e.g. chocolate, pralines, sweets, hard and soft caramels, chewing gum), cereal products (e.g. breakfast cereals, muesli bars), milk products (e.g. mild drinks, milk ice, yoghurt, kefir, fresh cheese, dried milk powder, reduced-fat butter, buttermilk, whey), fruit preparations (e.g. jams, marmalades, fruit ice, fruit sauces), snack articles (e.g. baked or fried potato crisps or potato pulp products, corn- or peanut-based extrudates), products based on fats and oils or emulsions thereof (e.g. mayonnaise, remoulade, dressings), alcoholic or non-alcoholic drinks (e.g. coffee, tea, wine, wine-containing drinks, beer, beer-containing drinks, liqueurs, whiskies, brandies, fruit-containing soft drinks, isotonic drinks, refreshment drinks, nectars, fruit and vegetable juices, fruit or vegetable juice preparations), instant drinks, ready meals and soups, seasonings, spice mixtures and especially sprinkle-on seasonings which are used in the snacks sector. Products according to the invention may also be used as semi-finished products for the production of further preparations used for nutrition or enjoyment. They may additionally be in the form of capsules, tablets (uncoated and coated tablets, e.g. enteric coatings), dragees, granules, pellets, solids mixtures, dispersions in liquid phases, in the form of emulsions, in the form of powders, in the form of solutions, in the form of pastes or in the form of other swallowable or chewable preparations as food supplements.

The divanillin-containing preparations according to the invention can be produced by incorporating the divanillin as a substance, as a solution or in the form of a mixture with a solid or liquid carrier into the flavouring composition or the foodstuff.

For the production of the preparations it is also possible in a further preferred embodiment for the divanillin and, optionally, other constituents of the preparation according the invention to be incorporated beforehand into emulsions, into liposomes, e.g. starting from phosphatidyl choline, into microspheres, into nanospheres or into capsules composed of a matrix suitable for foodstuffs and snacks, e.g. of starch, starch derivatives, other polysaccharides, natural fats, natural waxes or of proteins, e.g. gelatin. In a further embodiment, the divanillin according to the invention is complexed beforehand with suitable complexing agents, for example with cyclodextrins or cyclodextrin derivatives, preferably β-cyclodextrin, and is used in that form.

The ready-to-eat foodstuffs, semi-finished food products and flavouring compositions according to the invention can comprise further components, for example preservatives, antioxidants, emulsifiers, diluents, sugars, sugar substitutes, sugar alcohols, sweeteners, edible acids, colourings, colouring agents, pigments, taste-enhancing agents, taste-imparting substances, flavourings, nutraceuticals, trace elements, minerals, vitamins, plant extracts and roughage.

There may be used as preservatives the agents conventional for such purposes in the foodstuffs sector.

The following preservatives are advantageously used: cooking salt, sucrose, acetic acid, nitrites, especially Na, K and Ca nitrite, sulfites, especially Na, K and Ca sulfite. In addition, organic acids or their salts can be used, especially sorbic acid, benzoic acid, formic acid and the Na, K and Ca salts of these acids, as well as 4-hydroxybenzoic acid esters, salicylic acid and dehydracetic acid.

Suitable antioxidants and substances that can enhance the antioxidative action are the naturally occurring tocopherols and their derivatives, tocotrienols, flavonoids, ascorbic acid and its salts, alpha-hydroxy acids (e.g. citric acid, lactic acid, malic acid, tartaric acid) and their Na, Ka and Ca salts, ingredients, extracts or fractions thereof isolated from plants, e.g. from tea, green tea, algae, grapeseeds, wheatgerm, rosemary, oregano; flavonoids, quercertin, phenolic benzylamines. Further suitable antioxidants are propyl gallate, octyl gallate, dodecyl gallate, butylhydroxyanisole (BHA), butylhydroxytoluene (BHT), lecithins, mono- and di-glycerides of edible fatty acids esterified with citric acid, orthophosphates and Na, Ka and Ca salts of monophosphoric acid and ascorbyl palmitate.

Examples of suitable emulsifiers are lecithins, Na, K, Al, Mg and Ca salts of edible fatty acids, hydroxylated lecithin, mono- and di-glycerides of edible fatty acids, esterified with acetic acid, lactic acid, citric acid or monoacetyl- and diacetyl-tartaric acid, succinylated monoglycerides, ammonium phosphatides, monosodium phosphate derivatives of mono- and di-glycerides of edible fats or oils, or edible-fat-forming fatty acids, ethoxylated mono- and di-glycerides, sugar esters (esters of sucrose and edible fatty acids), polyglycerol polyricinoleate, propylene glycol esters of edible fatty acids, lactyl esters of edible fatty acids, sodium stearoyllactyl-2-lactate, calcium stearoyllactyl-2-lactate, stearyl tartrate, sorbitan monostearate, sorbitan tristearate, sorbitan monolaurate, sorbitan monooleate, sorbitan monopalmitate, polysorbate 20, polysorbate 40, polysorbate 60, polysorbate 65, polysorbate 80, stearyl-monoglyceridyl citrate, succistearin, copolymer condensation products of ethylene oxide and propylene oxide, dioctylsodium sulfosuccinate, sodium lauryl sulfate, sodium stearyl fumarate, lactylated fatty acid esters of glycerol and 1,2-propylene glycol.

The flavouring compositions or ready-to-eat foodstuffs or semi-finished food products according to the invention may comprise one or more diluents. Advantageous diluents are, for example, ethanol, triacetin and 1,2-propylene glycol.

Typical sugars which may be a constituent of the flavouring compositions or foodstuffs or semi-finished food products are glucose syrups, glucose-fructose syrups, isomerose syrups, isoglucose syrups, invert sugar syrups and crystalline sugars such as sucrose, glucose, lactose, hydrolysed lactose, sorbose, arabinose, xylose, mannose, maltose, galactose, maltotriose or fructose.

Suitable sugar substitutes are sugar alcohols, for example mannitol, sorbitol and sorbitol syrup, isomaltol (e.g. Palatinit®), maltol and maltol syrup, lactol, xylitol, erythritol, leucrose, arabinol, arabitol, adonitol, alditol, ducitol, iditol, as well as fructooligosaccharides (e.g. Ratfilose®), oligofructose or polydextrose.

As typical sweeteners which may be a constituent of the flavouring compositions or foodstuffs or semi-finished food products there may be mentioned saccharine (optionally in the form of the Na, K or Ca salt), aspartame (e.g. NutraSweet®), cyclamate (optionally in the form of the Na or Ca salt), acesulfame-K (e.g. Sunett®), thaumatin or neohesperidine dihydrochalcone. It is, of course, also possible to use other sweeteners, such as stevioside, rebaudioside A, glycyrrhicine, Ultrasweet, osladin, brazzein, miraculin, pentadin, phyllodulcin, dihydrochalcone, arylureas, trisubstituted guanidines, glycyrrhicine, superaspartame, suosan, sucralose (trichlorogalactosaccharose, TGS), alitame, monellin or Neotame®.

Suitable edible acids are, for example, citric acid, adipic acid, malic acid, fumaric acid, succinic acid, lactic acid, acetic acid, gluconic acid, tartaric acid.

As taste-enhancing agents there may be used substances such as sodium and potassium salts (e.g. sodium chloride, potassium chloride) and taste enhancers, for example maltol, furaneol to improve the sweet taste, and also sodium L-glutamate (MSG, glutamic acid), inosine 5′-monophosphate (IMP), 5-guanosine monophosphate (GMP), hydrolysed vegetable protein (HVP), yeast extracts, amino acids and sauce extracts, for example bouillon, soya sauce, spicy sauces, fish sauce, oyster sauce).

The flavouring compositions or ready-to-eat foodstuffs or semi-finished food products according to the invention may additionally optionally comprise substances or substance mixtures having nutritional-physiological activity (nutraceuticals). Examples which may be mentioned include vitamin A and derivatives, carotene, vitamin C (ascorbic acid), vitamin E (tocopherol) and derivatives, vitamins of the B and D groups, such as vitamin B₆ (nicotinamide), vitamin B₁₂, vitamin D₁, vitamin D₃, vitamin F, folic acid, biotin, amino acids, compounds of the elements magnesium, silicon, phosphorus, calcium, manganese, iron or copper, enzymes, for example bromelain, unsaturated fatty acids, ω-3-fatty acids, polyunsaturated fatty acids, γ-linolenic acid, oleic acid, eicosapentaenoic acid, docosahexaenoic acid and derivatives thereof, bisabolol, caffeine, capsaicin, thymol, camphor, extracts or other products of plant and animal origin, e.g. evening primrose oil, borage oil or locust bean oil, fish oils, fish-liver oil, ceramides and ceramide-like compounds, plant extracts, for example arnica, aloe, beard lichen, ivy, stinging nettle, ginseng, henna, camomile, marigold, rosemary, sage, horsetail or thyme, oils such as apricot kernel oil, avocado oil, babassu oil, cottonseed oil, borage oil, thistle oil, groundnut oil, gamma-oryzanol, rosehip oil, hemp oil, hazelnut oil, locust bean oil, jojoba oil, cherry kernel oil, salmon oil, linseed oil, maize oil, macadamia nut oil, almond oil, evening primrose oil, mink oil, olive oil, pecan nut oil, peach kernel oil, pistachio oil, rape oil, rice oil, castor oil, safflower oil, sesame oil, soybean oil, sunflower oil, tea tree oil, grapeseed oil or wheatgerm oil, roughage such as wheat fibre, orange fibre, apple fibre, carrot fibre, wheat bran, fructo-oligosaccharides (e.g. inulin).

As further constituents for the flavouring compositions, ready-to-eat foodstuffs or semi-finished food products according to the invention there may be used—as mentioned—basic substances, auxiliary substances and additives conventional for foodstuffs or snacks, for example water, mixtures of fresh or processed, vegetable or animal basic or raw substances (e.g. raw, roasted, dried, fermented, smoked and/or cooked meat, egg, bone, cartilage, fish, vegetable, fruits, herbs, nuts, vegetable or fruit juices or pastes or mixtures thereof), digestible or indigestible carbohydrates (e.g. sucrose, maltose, fructose, glucose, dextrins, amylose, amylopectin, inulin, xylans, cellulose), sugar alcohols (e.g. sorbitol), natural or hardened fats (e.g. tallow, lard, palm oil, coconut oil, hardened vegetable fat), oils, (e.g. sunflower oil, groundnut oil, maize oil, olive oil, thistle oil, fish oil, soybean oil, sesame oil), fatty acids or their salts (e.g. potassium stearate), proteinogenic or non-proteinogenic amino acids and related compounds (e.g. taurine, creatine, creatinine), peptides, natural or processed proteins (e.g. gelatin), enzymes (e.g. peptidases, glycosidases, lipases), nucleic acids, nucleotides, taste-modulating substances (e.g. sodium glutamate, 2-phenoxypropionic acid, hydroxyflavanones), emulsifiers (e.g. lecithins, diacylglycerols), stabilisers (e.g. carrageenan, alginate), preservatives (e.g. benzoic acid, sorbic acid), antioxidants (e.g. tocopherol, ascorbic acid), chelators (e.g. citric acid), organic or inorganic acidifying agents (e.g. malic acid, acetic acid, citric acid, tartaric acid, phosphoric acid), additional bitter substances (e.g. quinine, caffeine, limonine), sweeteners (e.g. saccharine, cyclamate, aspartame, neotame, neohesperidinedihydrochalcone, sucralose), mineral salts (e.g. sodium chloride, potassium chloride, magnesium chloride, sodium phosphates), substances that prevent enzymatic browning (e.g. sulfite, ascorbic acid), essential oils, plant extracts, natural or synthetic colourings or colouring pigments (e.g. carotinoids, flavonoids, anthocyanins, chlorophyll and derivatives thereof), spices, and also fragrances, synthetic, natural or nature identical flavouring and taste-imparting substances. The invention is illustrated by the following Examples.

### EXAMPLES

Unless indicated otherwise, all amounts are by weight.

### Example 1

10 g of vanillin are dissolved in 1000 ml of trisacetate buffer at pH 5 with heating at about 40-50° C. After cooling, 20 g of a 0.1 wt. % aqueous horseradish peroxidase solution (Aldrich, 550 U/mg) are added in metered amounts. 75 ml of hydrogen peroxide (3 wt. % in water) are then added dropwise over a period of 30 minutes with stirring. The solution is then allowed to stand for 18 hours at 35-38° C. The resulting divanillin is filtered off and washed thoroughly with water and methanol and oven-dried. About 9 g of divanillin having a purity of about 90 wt. % are obtained in this manner.

### Example 2

15 g of vanillin are added to a solution of 25 g of iron trichloride in 500 ml of water to form a suspension. The mixture is heated to 50° C. and stirred for a total of 4 hours. After cooling with an ice bath, the resulting divanillin is filtered off and washed with water and methanol and then dried. About 8 g of divanillin having a purity of about 90 wt. % are obtained in this manner.

### Example 3

Comminuted vanilla pods of various origins are extracted for 4-8 hours at 50° C. with about 5 times the amount of solvent. Suitable solvents are, for example, ethanol/water mixtures, methanol, pyridine, dimethyl sulfoxide or N,N-dimethylformamide. The extract is filtered, concentrated by evaporation and then analysed by HPLC-UV and LC-MS.

The divanillin concentrations indicated in the following table relate to the concentrations in the vanilla pod used.

| Origin | Solvent | Divanillin |
|---|---|---|
| Vanilla pods from Madagascar | Dimethyl sulfoxide | 13 ppm |
| Vanilla pods from Mexico | Methanol | 90 ppm |
| Vanilla pods from Tahiti | Ethanol/water 70 vol. % | 30 ppm |
| Vanilla pods from Tahiti | N,N-Dimethylformamide | 30 ppm |

### Example 4

Yoghurt composition with 0.1 % fat—amount of flavouring added 50 g/100 kg

| | | |
|---|---|---|
| Cream-vanilla flavouring | Standard | with divanillin |

| | | | | |
|---|---|---|---|---|
| Diacetyl | 10 | parts | 10 | parts |
| Acetoin | 10 | parts | 10 | parts |
| Anisaldehyde | 1 | part | 1 | part |
| Decalactone delta | 1 | part | 1 | part |
| Heliotropin | 40 | parts | 40 | parts |
| Vanillin | 150 | parts | 150 | parts |
| Silicon dioxide | 50 | parts | 50 | parts |
| Dextrose | 738 | parts | 738 | parts |
| Divanillin | 0 | parts | 10 | parts |

The yoghurt composition with the divanillin-containing flavouring is distinguished especially by a fuller taste as compared with the standard. The creamy notes are enhanced, the yoghurt acquires more richness and a markedly stronger note reminiscent of milk fat and cream. This character develops particularly in the after-taste.

### Example 5

Instant dessert with milk powder without added fresh milk—amount of flavouring added 50 g/100 kg

| | | |
|---|---|---|
| Cream-vanilla flavouring | Standard | with divanillin |

| | | | | |
|---|---|---|---|---|
| Diacetyl | 10 | parts | 10 | parts |
| Acetoin | 10 | parts | 10 | parts |
| Anisaldehyde | 1 | part | 1 | part |
| Decalactone delta | 1 | part | 1 | part |
| Heliotropin | 40 | parts | 40 | parts |
| Vanillin | 150 | parts | 150 | parts |
| Silicon dioxide | 50 | parts | 50 | parts |
| Dextrose | 738 | parts | 738 | parts |
| Divanillin | 0 | parts | 10 | parts |

The instant dessert with the divanillin-containing flavouring is distinguished especially by a fuller taste as compared with the standard. The creamy notes are enhanced, the instant dessert acquires more richness and a markedly stronger note reminiscent of milk fat and cream. This character develops particularly in the after-taste.

### Example 6

Ice-cream with a low fat content—amount of flavouring added 150 g/100 kg

| | | |
|---|---|---|
| Cream-vanilla flavouring | Standard | with divanillin |

| | | | | |
|---|---|---|---|---|
| Diacetyl | 10 | parts | 10 | parts |
| Acetoin | 10 | parts | 10 | parts |
| Anisaldehyde | 1 | part | 1 | part |
| Decalactone delta | 1 | part | 1 | part |
| Heliotropin | 40 | parts | 40 | parts |
| Vanillin | 150 | parts | 150 | parts |
| Silicon dioxide | 50 | parts | 50 | parts |
| Dextrose | 738 | parts | 738 | parts |
| Divanillin | 0 | parts | 10 | parts |

The ice-cream with the divanillin-containing flavouring is distinguished especially by a fuller taste as compared with the standard. The creamy notes are enhanced, the ice-cream acquires more richness and a markedly stronger note reminiscent of milk fat and cream. This character develops particularly in the after-taste.

### Example 7

Reduced-fat margarine (half-fat margarine)—amount of flavouring added 35 g/100 kg

| | | |
|---|---|---|
| Butter flavour | Standard | with divanillin |

| | | | | |
|---|---|---|---|---|
| gamma-Undecalactone | 1 | part | 1 | part |
| gamma-Nonalactone | 1 | part | 1 | part |
| Furaneol 15% in triacetin | 5 | parts | 5 | parts |
| gamma-decalactone | 10 | parts | 10 | parts |
| gamma-dodecalactone | 10 | parts | 10 | parts |
| diacetyl | 25 | parts | 25 | parts |
| delta-Dodecalactone | 50 | parts | 50 | parts |
| Caprylic acid | 50 | parts | 50 | parts |
| Butyric acid | 100 | parts | 100 | parts |
| delta-Decalactone | 100 | parts | 100 | parts |
| Vegetable oil triglycerides | 644 | parts | 644 | parts |
| Divanillin | 0 | parts | 5 | parts |

For use in half-fat margarine, flavours are sought that have a buttery, creamy character reminiscent of full fat. These requirements could be met only partially by the flavourings used hitherto.

As compared with the standard, the flavouring with added divanillin imparts a markedly improved taste profile of the butter type and a full-fat character.

1. A method for modifying the flavor of a consumable, comprising adding to said consumable a flavor modifying amount of divanillin as a flavouring.

2. The method as in claim 1, wherein said divanillin is added for imparting or enhancing a taste impression or a plurality of taste impressions from the group creaminess, adherence, milk fattiness, butteriness, sweetness and richness.

3. The method as in claim 1, wherein said consumable is a semi-finished food product or in a ready-to-eat foodstuff.

4. A flavouring composition for flavouring a foodstuff, comprising
divanillin,
vanillin and
optionally one or more further flavouring and/or taste-imparting substances,
the ratio of the amount of divanillin to vanillin being greater than 1:200.

5. A flavouring composition for flavouring a foodstuff, comprising
synthetic divanillin,
vanillin
and optionally one or more further flavouring and/or taste-imparting substances.

6. A flavouring composition for flavouring a semi-finished product or a ready-to-eat foodstuff, comprising
divanillin in an amount of from 0.1 to 50 wt. %, based on the total weight of the flavouring composition, and
one or more further flavouring and/or taste-imparting substances.

7. A ready-to-eat foodstuff or semi-finished food product comprising
divanillin in an amount in the range from the taste threshold value to 0.00099 wt. %, based on the total weight of the foodstuff, and
optionally one or more further flavouring and/or taste-imparting substances.

8. A ready-to-eat foodstuff or semi-finished food product, comprising
divanillin,
vanillin and
optionally one or more further flavouring and/or taste-imparting substances,
the ratio of the amount of divanillin to vanillin being greater than 1:200.

9. A ready-to-eat foodstuff or semi-finished food product, comprising
synthetic divanillin,
vanillin
and optionally one or more further flavouring and/or taste-imparting substances.

10. The method as in claim 3, wherein a sensorially effective amount of divanillin is added to the foodstuff to be flavoured, the amount of added divanillin not exceeding 0.00099 wt. %, based on the total weight of the flavoured food product or foodstuff.

11. The flavouring as in claim 4, wherein the ratio of the amount of divanillin to vanillin is greater than 1:100.

12. The flavouring as in claim 8, wherein the ratio of the amount of divanillin to vanillin is greater than 1:100.
